(19) United States
(12) Patent Application Publication
(10) Pub. No.: US 2006/0120726 A1
(43) Pub. Date: Jun. 8, 2006

(54) Remote control device and display device

(75) Inventors: Kohji Yoshifusa, Hiroshima (JP); Kohji Hisakawa, Nara (JP); Kazuhiko Matsumura, Nara (JP); Hajime Kashida, Nara (JP); Fumihiko Aoki, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/288,420

(22) Filed: Nov. 29, 2005

(30) Foreign Application Priority Data
Nov. 30, 2004 (JP) 2004-346760

(51) Int. Cl. H04B 10/00

(52) U.S. Cl. 398/106

(57) ABSTRACT

In an embodiment of the present invention, a remote control device is provided with an optical indicator device and a light-receiving device. A display device is provided with a display portion that displays a pointer and a frame portion that accommodates the light-receiving device. By displacing a light-emitting element sequencially to a plurality of displacement positions, supplying a light emission signal to the light-emitting element at each displacement position and to cause the light-emitting element to emit as output a position detection light signal, then sequencially detecting light-reception signals that are received as input by a position detection light-receiving element of the light-receiving device, and performing arithmetic processing as appropriate on the detected light-reception signals, a displacement state of a reference axis displacement angle is detected. Movement of a pointer is controlled by using the displacement state of the reference axis displacement angle as an indicating signal for the pointer.

### CROSS-REFERENCE TO RELATED APPLICATIONS

This application claims priority under 35 U.S.C. § 119(a) on Patent Application No. 2004-346760 filed in Japan on Nov. 30, 2004, the entire contents of which are hereby incorporated by reference.

### BACKGROUND OF THE INVENTION

1. Field of the Invention

The present invention relates to remote control devices that optically control a position of a mark such as a pointer (cursor) that is displayed on a display screen of a display device, at a position apart from the display device and to display devices that incorporate such a remote control device.

2. Description of the Related Art

Conventionally, remote control devices that perform control mechanically are known as devices for achieving operation of a cursor displayed on a display screen of a display device from a distant position. In remote control devices that perform control mechanically, a cross-shaped cursor key or a ball pointing device for example acts as a means for inputting position signals. In addition to these, coordinate input devices equipped with electrostatic pads or a joystick are also known.

In addition to the above-mentioned remote control devices that use mechanical control, remote control devices provided with a remote operation body that has a light-emitting element, and a controller portion that receives light from the remote operation body to detect indicated locations, have been proposed as optical remote coordinate indicating devices that use light-emitting elements (see Japanese Patents No. 3228864 and No. 3273531 for example).

The remote operation body of these remote coordinate indicating devices is provided with a central light-emitting element arranged centrally and an upward light-emitting element system, a downward light-emitting element system, a rightward light-emitting element system, and a leftward light-emitting element system arranged inclined such that their light axes are in a direction separated from the center of the central light-emitting element, and since a total of five light-emitting element systems are provided, it is a structurally complicated configuration, with the control system thereof similarly complicated. Furthermore, power consumption increases since a plurality of light-emitting elements are required, such that they have the problem of being impractical as a remote control device.

With conventional remote control devices, when moving the cursor to a desired position using the attached cross-shaped cursor key or the like, only stepped movements are possible and they can only move in four directions, which is vertically and laterally, so that they are insufficient for smooth diagonal movement.

Furthermore, with ball pointers, electrostatic pads, and joysticks, simple one-handed operation is not intuitive and it has not been possible to execute cursor movement in an intended manner.

Furthermore, with the proposed optical remote coordinate indicating device, many light-emitting elements are required, so that there has been a problem of being impractical as a remote control device.

### SUMMARY OF THE INVENTION

The present invention has been devised in consideration of these circumstances, and it is an object thereof to provide a remote control device that is capable of smoothly, speedily, and precisely controlling a position of a mark such as a pointer (cursor) displayed on a display screen of a display device and that is a low-power consumption type having a small number of light-emitting elements, by being provided with an optical indicator device having a light-emitting element that emits as output a position detection light signal, and a light-receiving device that receives as input the position detection light signal from the optical indicator device to detect a light-reception signal and obtains a position signal from the light-reception signal.

Furthermore, another object is to provide a display device in which a pointer displayed on a display screen of the display device can be controlled freely by being provided with the aforementioned remote control device.

A remote control device according to the present invention is provided with an optical indicator device in which a light-emitting element is mounted that emits as output a position detection light signal, and a light-receiving device that receives as input the position detection light signal and obtains a position signal from a detected light-reception signal, wherein the optical indicator device is provided with a light axis control portion that displaces a light axis of the light-emitting element to displacement positions so that the light axis of the light-emitting element has an inclination angle with respect to a reference axis of the optical indicator device, and a light emission control portion that causes a position detection light signal to be emitted as output from the light-emitting element when the light axis of the light-emitting element is in the displacement positions.

With this configuration, the position detection light signal is emitted as output while the light axis of the light-emitting element is displaced to a displacement position, and therefore the position signal can be obtained by performing arithmetic processing on the light-reception signal of a level corresponding to a displacement state (reference axis displacement angle) of the reference axis of the optical indicator device. Using this position signal, it becomes possible to control the position of a mark such as a pointer (cursor) displayed on a display screen for example. Furthermore, since a single light-emitting element is sufficient, the light axis control portion can be configured easily and a remote control device that consumes little power is achieved.

In the remote control device according to the present invention, it is possible that the displacement positions are arranged in symmetrical positions centering on the reference axis. With this configuration, since the light axes are arranged symmetrically, control of the displacement positions of the light axes and arithmetic processing are simplified, thus improving detection accuracy.

In the remote control device according to the present invention, it is possible that the displacement positions are in at least four locations. With this configuration, it is possible to achieve two-dimensional (X-Y) position detection with high accuracy and few displacement positions.

In the remote control device according to the present invention, it is possible that the light axis control portion comprises a mechanical component that mechanically controls the displacement positions of the light axis. With this configuration, since a mechanical component is used, the displacement position of the light axis can be controlled comparatively easily.

In the remote control device according to the present invention, it is possible that the light axis control portion comprises an electromagnetic drive device that electromagnetically controls the displacement positions of the light axis. With this configuration, an electromagnetic drive device is used, and therefore synchronization to the light emission control portion can be achieved easily, thus allowing precise control and miniaturization and simplification of the light axis control portion.

In the remote control device according to the present invention, it is possible that a light axis control signal applied to the electromagnetic drive device has two types of pulse waves having different phases. With this configuration, the light axis is fixed in a displacement position in a period (amplitude value period) in which a pulse is applied and stays in a predetermined level, and the position detection light signal can be emitted as output synchronized to the displacement positions, and therefore stable light emission control can be achieved and detection accuracy of light-reception signals can be improved.

In the remote control device according to the present invention, it is possible that the two types of pulse waves are respectively step shaped waveforms, with a cycle of each step in one of the types of pulse waves being equivalent to a cycle of a group of steps in another of the types of pulse waves. With this configuration, the displacement positions of the light axis can be formed into a fine matrix shape and the control resolution for the displacement states of the reference axis can be improved, thus making possible more precise detection of the position signals.

In the remote control device according to the present invention, it is possible that the light emission control portion applies a light emission signal of pulse waves to the light-emitting element in synchronization to the displacement positions. With this configuration, the light emission signals are set to pulse waves so that synchronization of the displacement positions of the light axis and the position detection light signals can be achieved reliably, and therefore the light-reception signals corresponding to the displacement positions can be specified easily and light-reception signal detection can be carried out with excellent accuracy.

In the remote control device according to the present invention, it is possible that the light emission signal includes a detection start pulse and a position detection pulse after the detection start pulse. With this configuration, the light emission signals are divided into detection start pulses and position detection pulses, with the detection start pulses being produced first, and therefore the commencement of position detection at the light-receiving device can be carried out reliably, thus enabling detection accuracy of the light-reception signals to be improved.

In the remote control device according to the present invention, it is possible that the position detection pulses are constituted by a plurality of pulses having a same pulse width and a same cycle with respect to the respective displacement positions. With this configuration, a plurality of same pulses are repetitively produced, and therefore a plurality of amplitude values of light-reception signals can be averaged and used as an amplitude value at the light-receiving device so that the accuracy of signal processing can be further improved.

In the remote control device according to the present invention, it is possible that a modulation carrier wave is superimposed onto the light emission signal. With this configuration, modulation carrier wave is superimposed onto the position detection light signal so that it is possible to eliminate the influence of disturbance light (noise), and therefore detection accuracy can be improved.

In the remote control device according to the present invention, it is possible that the light-emitting element emits as output a light emission wavelength of an infrared light region. With this configuration, infrared light is used for the position detection light signals so that it is possible to eliminate the influence of disturbance light (noise), and therefore detection accuracy can be improved.

In the remote control device according to the present invention, it is possible that the inclination angle is not greater than a half value angle of the light-emitting element. With this configuration, since the inclination angle is set to not greater than a half value angle, a position detection light signal having excellent directivity can be obtained, and therefore the position detection light signals can be detected with excellent accuracy.

In the remote control device according to the present invention, it is possible that the light-receiving device is provided with a position detection light-receiving element that receives as input the position detection light signal to detect a light-reception signal, an amplifier circuit that amplifies the light-reception signal detected by the position detection light-receiving element, an amplitude value detection circuit that detects an amplitude value of the light-reception signal amplified by the amplifier circuit, and an arithmetic processing portion that performs arithmetic processing on the amplitude value to obtain the position signal.

With this configuration, the amplitude values of the light-reception signals can be regulated to appropriate values (output levels) by the amplifier circuit and detected by the amplitude value detection circuit, and therefore the output levels (relative light intensities) of the light-reception signals can be detected with excellent accuracy and ease. Furthermore, since the output levels of the light-reception signals can be controlled to appropriate values, precise arithmetic processing becomes possible and arithmetic processing is performed on the amplitude values by the arithmetic processing portion, and therefore the position signals can be obtained with excellent accuracy and ease.

In the remote control device according to the present invention, it is possible that amplitude values obtained for a plurality of pulses of light-reception signals corresponding to the plurality of pulses of the position detection pulses are averaged and the average is set as an amplitude value of the light-reception signals. With this configuration, the amplitude values of a plurality of pulses of light-reception pulses corresponding to position detection pulses constituted by the plurality of pulses emitted as output synchronized to the respective displacement positions are averaged, and therefore it is possible to achieve light-reception signals having very excellent accuracy and position detection can be performed with excellent accuracy.

In the remote control device according to the present invention, it is possible that a band-pass filter is connected between the amplifier circuit and the amplitude value detection circuit. With this configuration, since a band-pass filter is used, amplitude values are obtained for light-reception signals from which signals (noise) other than the predetermined frequency have been eliminated, and therefore the detection accuracy of light-reception signals can be improved.

In the remote control device according to the present invention, it is possible that an amplification factor of the amplifier circuit is regulated by an automatic gain control circuit. With this configuration, the amplification factor of the amplifier circuit can be controlled using an automatic gain control circuit, and therefore the output levels of the light-reception signals can be regulated to appropriate values and arithmetic processing can be carried out easily and precisely.

In the remote control device according to the present invention, it is possible that the amplification factor is regulated such that the amplitude value of the light-reception signal does not saturate. With this configuration, the amplitude values of the light-reception signals do not saturate, and therefore precise light-reception signals (output levels, amplitude values) can be obtained with high reliability.

In the remote control device according to the present invention, it is possible that the amplitude value is obtained by setting as a reference level a noise level of the light-reception signal in a period in which there is no signal, and obtaining a difference from the reference level. With this configuration, since the level (amplitude value) of the light-reception signal is obtained based on a reference level in which noise has been removed, accurate light-reception signals (amplitude values) can be obtained and the detection accuracy of light-reception signals can be improved.

A display device according to the present invention is provided with a display portion that displays information and a frame portion that supports the display portion, and is provided with the remote control device according to the present invention, wherein the light-receiving device is arranged at a front surface of the frame portion.

With this configuration, the light-receiving device can be confirmed visually, and therefore the direction of the reference axis of the optical indicator device can be accurately turned toward the direction of the light-receiving device, thereby enabling the position detection light signals to be reliably received as input.

In the display device according to the present invention, it is possible that the optical indicator device emits as output and transmits to the light-receiving device a function control light signal corresponding to a function control signal that controls a function of the display device, and the light-receiving device receives as input the function control light signal and outputs the function control signal. With this configuration, in addition to position detection (position control) of a mark (pointer), it is possible to control functions of the display device, and therefore it is possible to achieve a display device provided with a remote control device with high usefulness.

In the display device according to the present invention, it is possible that the function control light signal is emitted as output from the light-emitting element. With this configuration, the light-emitting element that emits as output the position detection light signals, and the light-emitting element that emits as output the function control light signals can be combined in use, and therefore mounting of the light-emitting element can be simplified and the mechanical structure of the optical indicator device can be simplified.

In the display device according to the present invention, it is possible that the light-receiving device comprises a function control light-receiving element that receives as input the function control light signal. With this configuration, since a light-receiving device provided with a function control light-receiving element is used, reliable detection of the function control light signals can be achieved and function control of the display device can be carried out reliably.

In the display device according to the present invention, it is possible that the position detection light-receiving element receives as input the function control light signal and detects the function control signal. With this configuration, the mounting of the light-receiving device (light-receiving element) can be simplified by combining in use the position detection light-receiving element and the function control light-receiving element.

In the display device according to the present invention, it is possible that a position of a mark displayed on the display portion is controlled according to the position signal. With this configuration, the position of the mark, such as a pointer, displayed on the display portion of a display device can be controlled easily.

In the display device according to the present invention, the display device may be a television receiver. With this configuration, a television receiver can be achieved provided with a new function (an optical pointing function).

As mentioned above, a remote control device according to the present invention is provided with an optical indicator device having a light-emitting element that emits as output a position detection light signal and a light-receiving device that receives as input the position detection light signal to detect a light-reception signal and obtains a position signal from the light-reception signal, and the light axis of the light-emitting element is displaced to predetermined displacement positions while the position detection light signals are emitted as output synchronized to the displacement positions, and therefore a light-reception signal of a level (amplitude value) corresponding to the displacement state (reference axis displacement angle) of the reference axis of the optical indicator device can be detected and arithmetic processing is performed on the amplitude values of the light-reception signals, so that position signals (of the reference axis) of the optical indicator device can be obtained.

Accordingly, with a remote control device according to the present invention, an effect is achieved by which it is possible to achieve a remote control device having excellent operability for smoothly, speedily, and precisely controlling a position of a mark such as a pointer (cursor) displayed on a display screen of a display device for example using the position signals.

Furthermore, a single light-emitting element is sufficient for emitting as output the position detection light signals, so that an effect is achieved by which a low power consumption type remote control device is achieved at low cost and with excellent operability since the structure of the optical indicator device is simplified having few light-emitting elements.

With the display device according to the present invention, since a display device is provided that accommodates a light-receiving device incorporating a remote control device according to the present invention, an effect is achieved by which a display device can be provided that is capable of freely controlling the position of a mark (cursor, pointer) displayed on a display screen.

### BRIEF DESCRIPTION OF THE DRAWINGS

FIG. 1 is an explanatory diagram that shows an outline of principal components of a remote control device according to the present invention and a display device according to the present invention provided with such a remote control device.

FIGS. 2A and 2B are explanatory diagrams for describing forms of displacement positions (of the light-emitting elements for position detection) of the optical indicator devices of remote control devices according to the present invention.

FIGS. 3A and 3B are explanatory diagrams for describing forms of displacement positions (of the light-emitting elements for position detection) of the optical indicator devices of remote control devices according to the present invention.

FIGS. 4A and 4B are explanatory diagrams for describing forms of displacement positions (of the light-emitting elements for position detection) of the optical indicator devices of remote control devices according to the present invention.

FIGS. 5A and 5B are explanatory diagrams for describing forms of displacement positions (of the light-emitting elements for position detection) of the optical indicator devices of remote control devices according to the present invention.

FIGS. 6A and 6B are explanatory diagrams for describing forms of displacement positions (of the light-emitting elements for position detection) of the optical indicator devices of remote control devices according to the present invention.

FIG. 7 is an explanatory diagram for describing a principle by which a reference axis displacement angle is detected in a remote control device according to the present invention, and is a graph showing correlation between the relative light intensity of the position detection light signal (light-reception signal) detected by the position detection light-receiving element and the reference axis displacement angle as a relative light intensity to reference axis displacement angle characteristic.

FIGS. 8A and 8B are explanatory diagrams for illustrating a structure of an electromagnetic drive device as another working example of a light axis control portion. FIG. 8A is a front view showing principal components of the electromagnetic drive device as seen from a light-receiving device (light-receiving element) side (that is, as viewed from the front) and FIG. 8B is an outline cross section showing principal components along the line from the arrows 8B-8B in FIG. 8A.

FIGS. 9A through 9D are explanatory diagrams for describing examples of the light axis control signals (electric current waveforms) that are supplied to the movable coils of the electromagnetic drive device shown in FIGS. 8A and 8B. FIG. 9A is a wiring explanatory diagram illustrating an outline of the circuit structure, FIG. 9B is a waveform diagram of when the light axis control signal is set to a sine wave, and FIGS. 9C and 9D are waveform diagrams of when the light axis control signal is set to a pulse wave.

FIG. 10 is an outline circuit block diagram for describing an outline circuit of an optical indicator device according to the present invention using an electromagnetic drive device as a light axis control portion.

FIGS. 11A and 11B are waveform diagrams showing waveform examples of the light emission signals applied to the position detection light-emitting elements to emit as output the position detection light signals and the light-reception signals obtained from the position detection light signals that the position detection light-receiving elements receive as input.

FIG. 12 is a block diagram showing a working example of a circuit block of the light-receiving device in a remote control device according to the present invention.

FIG. 13 is a pattern diagram that schematically illustrates a front view of an example of a light axis distribution pattern (M×N matrix) when the number of light axis displacement positions has been increased.

FIG. 14 is a lateral schematic view showing displacement states of light axes corresponding to when the line M=3 in FIG. 13 along with lateral principal components of the optical indicator device.

FIGS. 15A and 15B are waveform diagrams of working examples of the light axis control signals applied to the movable coils to set the displacement position of the light axis shown in FIG. 13.

FIGS. 16A and 16B are waveform diagrams for describing waveform examples of the light emission signals applied to the position detection light-emitting elements synchronized to the light axis displacement positions shown in FIGS. 13, 15A and 15B and the light-reception signals obtained from the position detection light signals that the position detection light-receiving elements receive as input.

FIGS. 17A through 17C are explanatory diagrams (lateral perspective views) for describing a working example in which the displacement position of the light axis of the light-emitting element is controlled using a reflective component in the light axis control portion of the optical indicator device shown in FIGS. 2A and 2B.

### DESCRIPTION OF THE PREFERRED EMBODIMENTS

Hereinafter, embodiments of the present invention will be described with reference to the accompanying drawings.

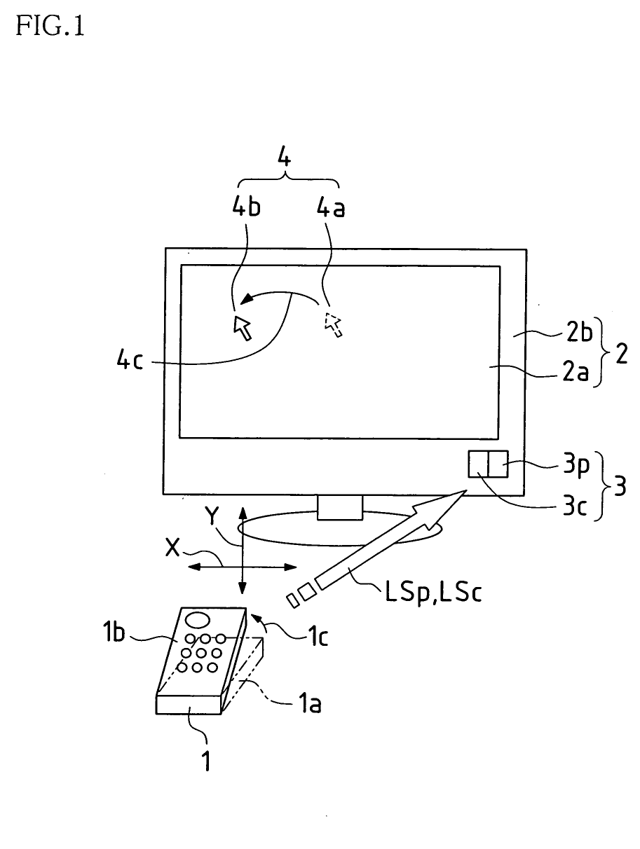

FIG. 1 is an explanatory diagram that shows an outline of principal components of a remote control device according to the present invention and a display device according to the present invention provided with such a remote control device.

A remote control device according to the present invention is a so-called remote controller and is constituted by an optical indicator device 1 and a light-receiving device 3. Furthermore, a display device 2 according to the present invention accommodates the light-receiving device 3 of the remote control device according to the present invention. The display device 2, which is a monitor or a television receiver or the like that displays information such as images and data, has a display portion 2a at a central area of a front surface and a frame portion 2b that supports the display portion 2a is provided at the perimeter thereof. The light-receiving device 3 is arranged (contained) at a front surface of the frame portion 2b. It should be noted that the light-receiving device 3 may also be provided in the display portion 2a.

A pointer 4 is displayed on the display screen of the display portion 2a as a mark (cursor). A before-movement pointer 4a, an after-movement pointer 4b, and a movement trajectory 4c of the pointer 4 are shown schematically in this drawing.

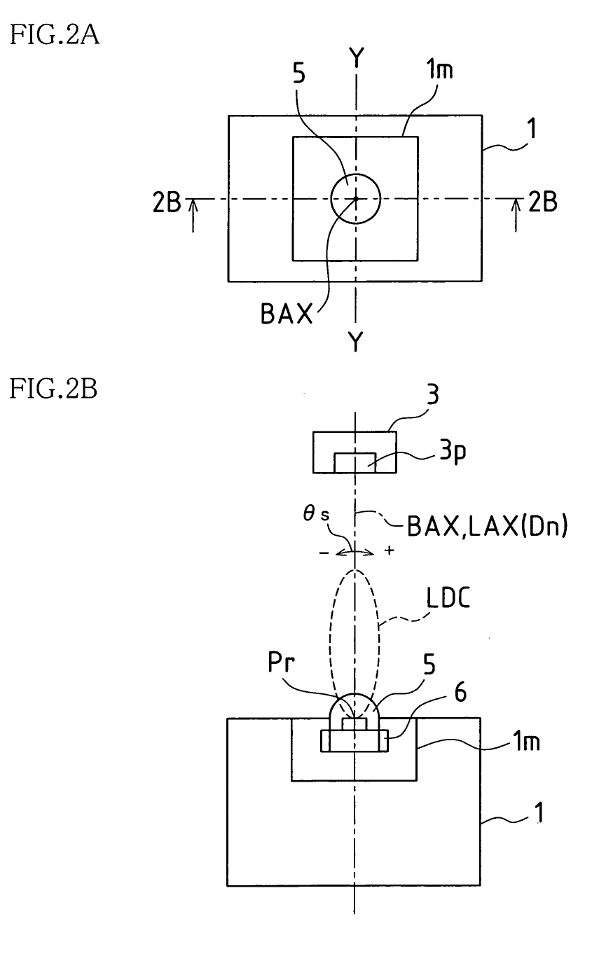

The optical indicator device 1 emits as output a position detection light signal LSp and a function control light signal LSc, which are transmitted to the light-receiving device 3. The position detection light signal LSp and the function control light signal LSc may be in a form in which these signals are transmitted from separate optical indicator devices, but configuring these signals such that they are emitted as output from a single optical indicator device 1 is preferable since this allows the structure of the remote control device to be simplified. It should be noted that a form of light emission output of the position detection light signal LSp is described with FIGS. 2A through 6B.

The light-receiving device 3 is provided with a position detection light-receiving element 3p, which is for receiving as input (detecting) the position detection light signal LSp, and a function control light-receiving element 3c, which is for receiving as input (detecting) the function control light signal LSc. It should be noted that it is possible to combine the position detection light-receiving element 3p and the function control light-receiving element 3c by devising the control mode and transmission mode. That is, a configuration is possible in which the function control light signal LSc is received as input by the position detection light-receiving element 3p to detect a function control signal.

When (a reference axis BAX (see FIGS. 2A and 2B) of the optical indicator device 1 is moved from an optical indicator device 1a to an optical indicator device 1b as shown by the movement trajectory 1c, the position detection light signal LSp that is received as input by the position detection light-receiving element 3p tracks this movement and changes accordingly. By detecting the position detection light signal LSp as a light-reception signal, the light-receiving device 3 is capable of conducting arithmetic processing to detect (output) change in the light-reception signal as a position signal.

Accordingly, the display position of the pointer 4 can be controlled and made to move in response to the detected position signal. It should be noted that an X-axis (horizontal direction movement) as a first direction and a Y-axis (vertical direction movement) as a second direction intersecting the first direction are shown as examples of detection references for when detecting movement of (the reference axis BAX of) the optical indicator device 1. To simplify the arithmetic processing and to improve detection accuracy, it is very preferable that the intersecting angle of the first direction and the second direction is set to 90 degrees as with the X-axis and Y-axis.

The function control light signal LSc is emitted as output (transmitted) in response to a function control signal for controlling the functions of the display device 2. In the case of the display device 2 being a television receiver for example, the function control signal includes control signals such as a channel selection signal, a volume adjustment signal, a brightness adjustment signal, and signals for turning on/off buttons on the display screen using the pointer 4. The function control light signal LSc received by the function control light-receiving element 3c is detected (outputted) by the light-receiving device 3 as a function control signal and the function of the display device 2 is controlled in response to the detected function control signal.

In the remote control device according to the present invention, by performing arithmetic processing on the light-reception signal that corresponds to the position detection light signal LSp that controls the position of the pointer 4 to detect the movement direction of the reference axis BAX of the optical indicator device 1 in addition to the function control light signal LSc that is ordinarily used, it is possible to achieve synchronization to the movement direction of the reference axis BAX and to simply move the pointer 4 on the display screen to a desired position and it is possible to achieve high-speed, smooth movement control of the position of the pointer 4 compared to conventional remote control devices that perform control mechanically.

FIGS. 2A through 6B are explanatory diagrams for describing forms of displacement positions (of the light-emitting elements for position detection) of the optical indicator devices of remote control devices according to the present invention. Identical symbols are attached to structures identical to FIG. 1 and description thereof is omitted as appropriate.

FIGS. 2A and 2B are explanatory diagrams illustrating when the reference axis BAX of the optical indicator device 1 and the light axis LAX of a light-emitting element 5 for position detection are in accordance (the light axis of the light-emitting element 5 is in a neutral point position Dn). FIG. 2A is a front view showing principal components of the optical indicator device 1 as seen from a light-receiving device 3 (position detection light-receiving element 3p) side (that is, as viewed from the front), and FIG. 2B is a lateral perspective view showing principal components along the line from the arrows 2B-2B in FIG. 2A. It should be noted that in FIG. 2B, the light-receiving device 3 (the position detection light-receiving element 3p) is illustrated for reference.

The reference axis BAX of the optical indicator device 1, in general, faces from an optical indicator device 1 (from the center of the light-emitting element 5) to the light-receiving device 3 (the position detection light-receiving element 3p). When performing positional control of the pointer 4, the position detection light signal LSp is emitted as output from the light-emitting element 5 in a state in which the reference axis BAX is, as appropriate, displaced leftward, rightward, upward, or downward with respect to the center of the position detection light-receiving element 3p with a reference axis displacement angle θs corresponding to the control (movement direction, movement amount) of the pointer 4 desired to be moved. It should be noted that the reference axis BAX is a hypothetical line (indication direction) formed by the optical indicator device 1 when the optical indicator device 1 (light-emitting element 5) directly faces the light-receiving device 3.

The position detection light signal LSp (that is, the light-reception signal) that is received as input by the position detection light-receiving element 3p changes in response to displacement of the reference axis BAX (the reference axis displacement angle θs), and therefore movement control of the pointer 4 is carried out by detecting the light-reception signal that is received as input by the position detection light-receiving element 3p and obtaining a position signal (position control signal) by carrying out arithmetic processing, as appropriate.

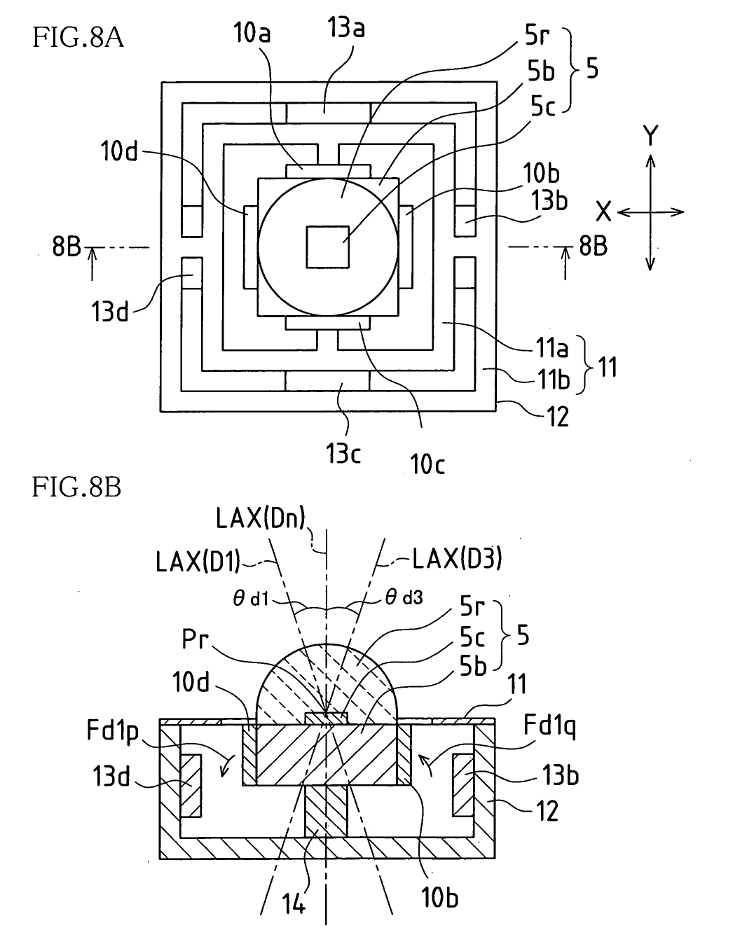

The light-emitting element 5 is arranged mounted at a central structural portion 1m of the front surface (surface facing the light-receiving device 3) of the optical indicator device 1. The light-emitting element 5 is constituted for example by a light-emitting diode (LED) chip 5c (see FIGS. 8A and 8B) placed on a substrate portion 5b (see FIGS. 8A and 8B) and a convex resin lens portion 5r (see FIGS. 8A and 8B) covering the surface thereof. A light axis control portion 6 that controls the direction of the light axis of the light-emitting element 5 is arranged connected to the substrate portion 5b of the light-emitting element 5.

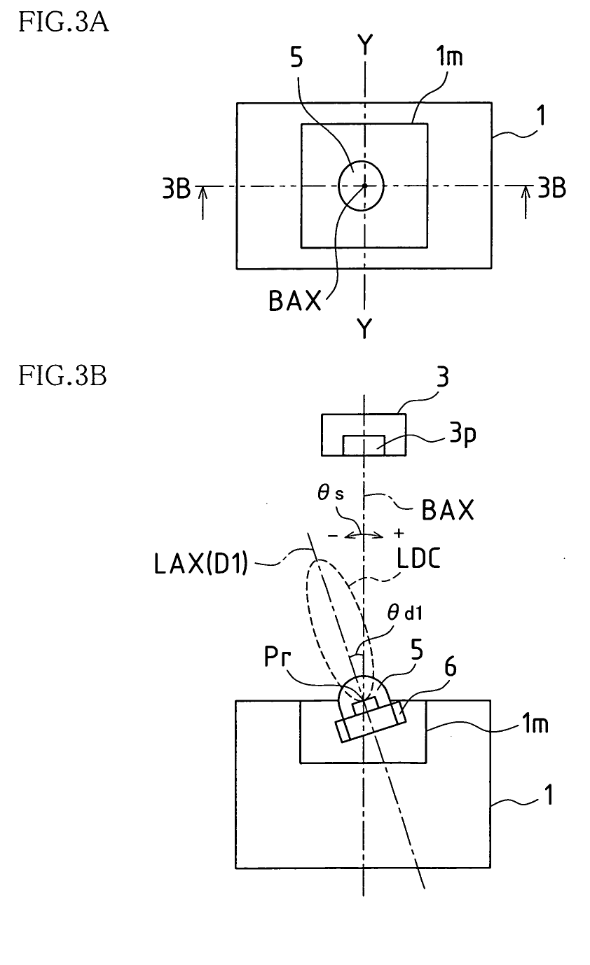

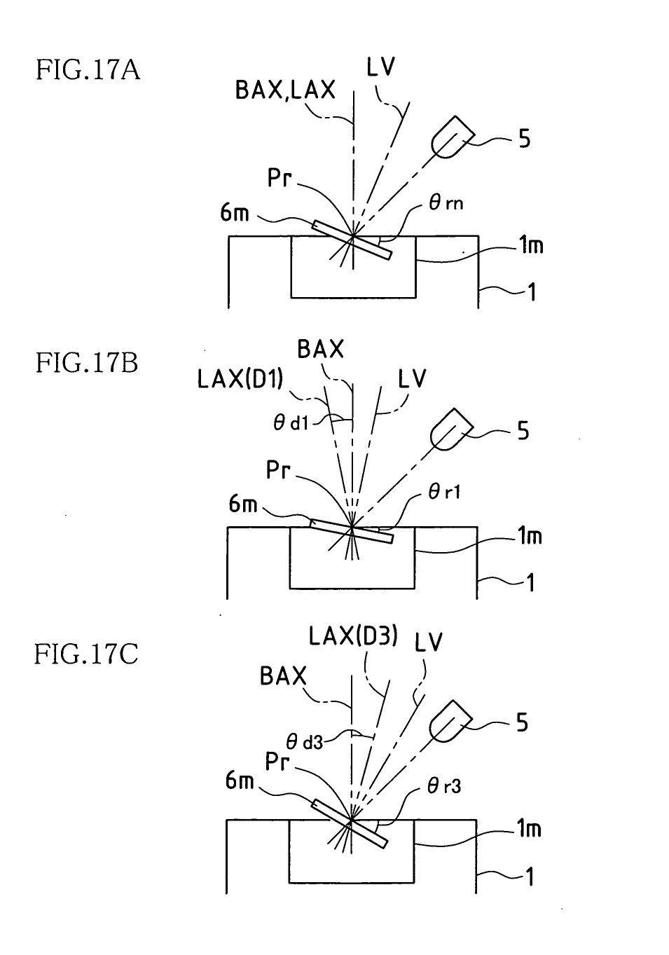

The light axis control portion 6 is configured incorporating a mechanical component such as an appropriate gear or ring rail for example so as to be capable of mechanically controlling (examples of control shown in FIGS. 3A through 6B) the displacement direction (displacement position) of a light axis LAX of the light-emitting element 5, centered on a displacement center Pr. When using a rotational body such as a ring rail, the light axis LAX can be displaced in an inverted cone shape having the reference axis BAX as a center. And when a mechanical component such as a rotational body is used, the displacement position of the light axis LAX can be controlled comparatively easily. Furthermore, it is also possible to use a reflective component 6m or the like in which the light axis LAX can be displaced by rotating (tilting) around the reference axis BAX (displacement center Pr) (see FIGS. 17A through 17C).

The light-emitting element 5 has a light intensity distribution characteristic LDC. This can be selected to have appropriate light intensity and directivity according to usage environment conditions (distance between the optical indicator device 1 and the display device 2, for example).

It is preferable that the light-emitting element 5 emits as output a light emission wavelength of the infrared light region. By using a light emission wavelength of the infrared light region, it is possible to eliminate the influence of disturbance light (noise), and therefore detection accuracy can be improved.

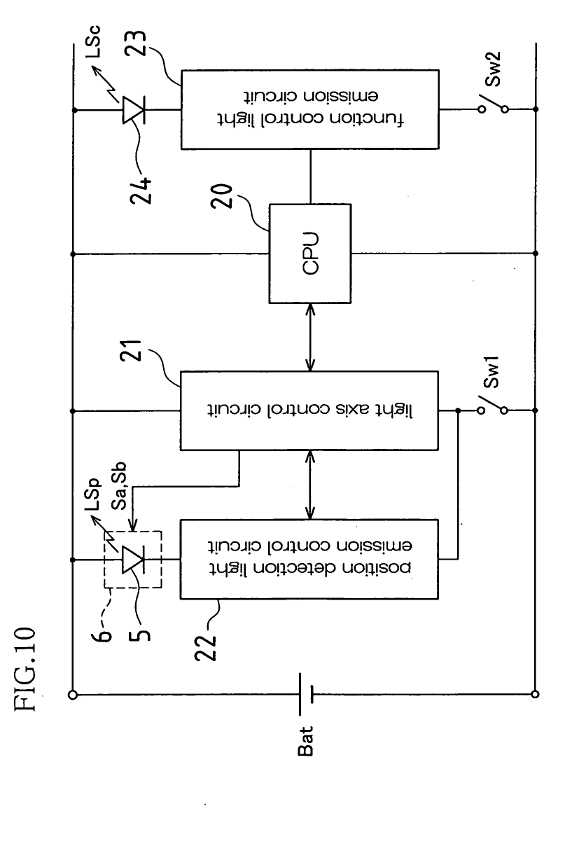

It should be noted that by making combined use of the light-emitting element 5 and a light-emitting element 24 (see FIG. 10), that is, by allowing the light-emitting element 5 to function as the light-emitting element 24 when the light axis LAX of the light-emitting element 5 is at the neutral point position Dn to emit as output (transmit) a function control light signal LSc, it is possible to reduce the number of light-emitting elements and also carry out stable function control.

FIGS. 3A and 3B are explanatory diagrams illustrating when the light-emitting element 5 has been displaced such that the light axis LAX of the light-emitting element 5 has an inclination angle θd1 in the horizontal and leftward direction as viewed from the front (displacement position D1) with respect to the reference axis BAX of the optical indicator device 1. FIG. 3A is a front view showing the optical indicator device 1 as seen from the light-receiving device 3 (position detection light-receiving element 3p) side (that is, as viewed from the front), and FIG. 3B is a perspective view showing principal components along the line from the arrows 3B-3B (corresponding to a horizontal direction (first direction) of the optical indicator device 1) in FIG. 3A. It should be noted that the position detection light-receiving element 3p is illustrated for reference. Furthermore, “displacement of the light-emitting element 5” is essentially synonymous to “displacement of the light axis LAX of the light-emitting element 5.”

The displacement position D1 (inclination angle θd1) can be achieved by rotating the light-emitting element 5 centered on the displacement center Pr, as appropriate, using the light axis control portion 6. To enhance detection accuracy, it is preferable that the inclination angle θd1 is not greater than a half value angle θh. It should be noted that the half value angle θh indicates the directivity of the light-emitting intensity of the light-emitting element and is an angle from the light axis of a point at which the light intensity becomes half the maximum value in the light intensity distribution characteristics. That is, a position detection light signal LSp having good directivity can be achieved by using a setting of not greater than the half value angle θh, and therefore precise reception of input can be achieved by the light-receiving device 3 (position detection light-receiving element 3p) and the position detection light signal can be detected with excellent accuracy, thus it is possible to achieve a remote control device having excellent accuracy.

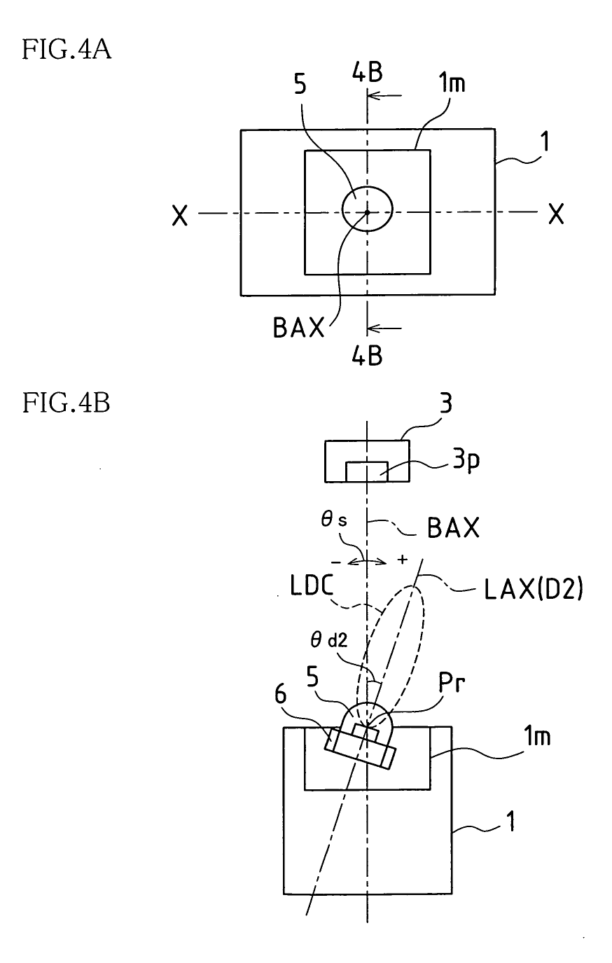

FIGS. 4A and 4B are explanatory diagrams illustrating when the light-emitting element 5 has been displaced such that the light axis LAX of the light-emitting element 5 has an inclination angle θd2 in the vertical and upward direction as viewed from the front (displacement position D2) with respect to the reference axis BAX of the optical indicator device 1. FIG. 4A is a front view showing the optical indicator device 1 as seen from the light-receiving device 3 (position detection light-receiving element 3p) side (that is, as viewed from the front), and FIG. 4B is a perspective view showing principal components along the line from the arrows 4B-4B (corresponding to a vertical direction (a second direction intersecting vertically with the first direction) of the optical indicator device 1) in FIG. 4A. It should be noted that the position detection light-receiving element 3p is illustrated for reference.

The displacement position D2 (inclination angle θd2) can be achieved by rotating the light-emitting element 5 centered on the displacement center Pr, as appropriate, using the light axis control portion 6. To enhance detection accuracy, it is preferable that the inclination angle θd2 is not greater than the half value angle θh.

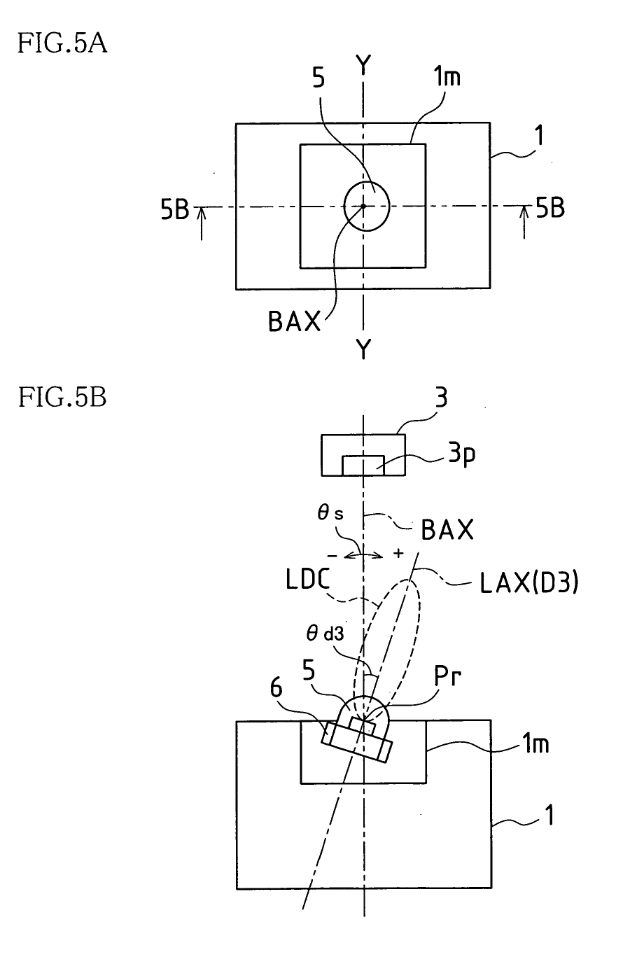

FIGS. 5A and 5B are explanatory diagrams illustrating when the light-emitting element 5 has been displaced such that the light axis LAX of the light-emitting element 5 has an inclination angle θd3 in the horizontal and rightward direction as viewed from the front (displacement position D3) with respect to the reference axis BAX of the optical indicator device 1. FIG. 5A is a front view showing the optical indicator device 1 as seen from the light-receiving device 3 (position detection light-receiving element 3p) side (that is, as viewed from the front), and FIG. 5B is a perspective view showing principal components along the line from the arrows 5B-5B in FIG. 5A. It should be noted that the position detection light-receiving element 3p is illustrated for reference.

The displacement position D3 (inclination angle θd3) can be achieved by rotating the light-emitting element 5 centered on the displacement center Pr, as appropriate, using the light axis control portion 6. To enhance detection accuracy, it is preferable that the inclination angle θd3 is not greater than the half value angle θh. It should be noted that to facilitate control of the light axis LAX and improve detection accuracy, it is preferable that the displacement position D3 is arranged in a symmetrical position to the displacement position D1 centering on the reference axis BAX.

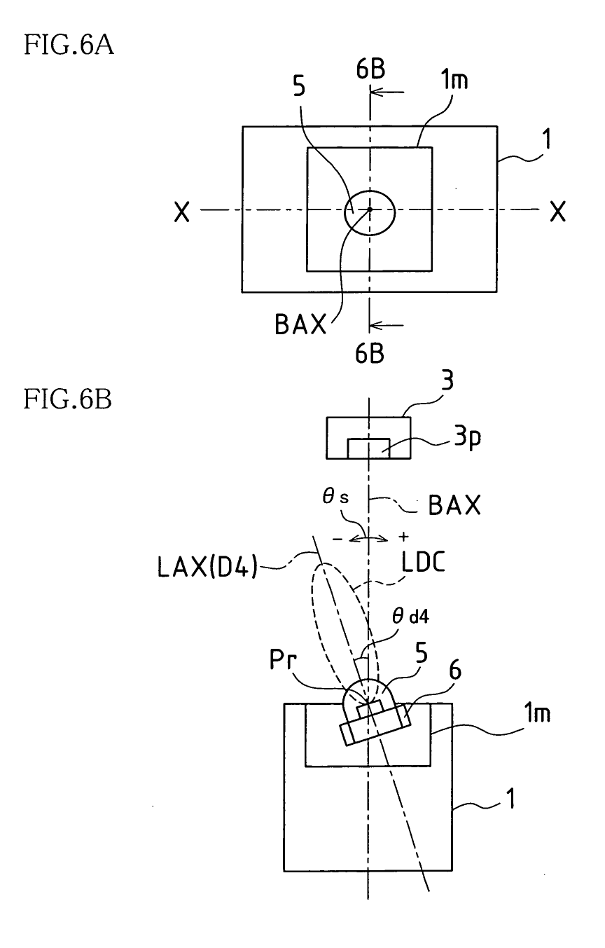

FIGS. 6A and 6B are explanatory diagrams illustrating when the light-emitting element 5 has been displaced such that the light axis LAX of the light-emitting element 5 has an inclination angle θd4 in the vertical and downward direction as viewed from the front (displacement position D4) with respect to the reference axis BAX of the optical indicator device 1. FIG. 6A is a front view showing the optical indicator device 1 as seen from the light-receiving device 3 (position detection light-receiving element 3p) side (that is, as viewed from the front), and FIG. 6B is a perspective view showing principal components along the line from the arrows 6B-6B in FIG. 6A. It should be noted that the position detection light-receiving element 3p is illustrated for reference.

The displacement position D4 (inclination angle θd4) can be achieved by rotating the light-emitting element 5 centered on the displacement center Pr, as appropriate, using the light axis control portion 6. To enhance detection accuracy, it is preferable that the inclination angle θd4 is not greater than the half value angle θh. It should be noted that to facilitate control of the light axis LAX and improve detection accuracy, it is preferable that the displacement position D4 is arranged in a symmetrical position to the displacement position D2 centering on the reference axis BAX.

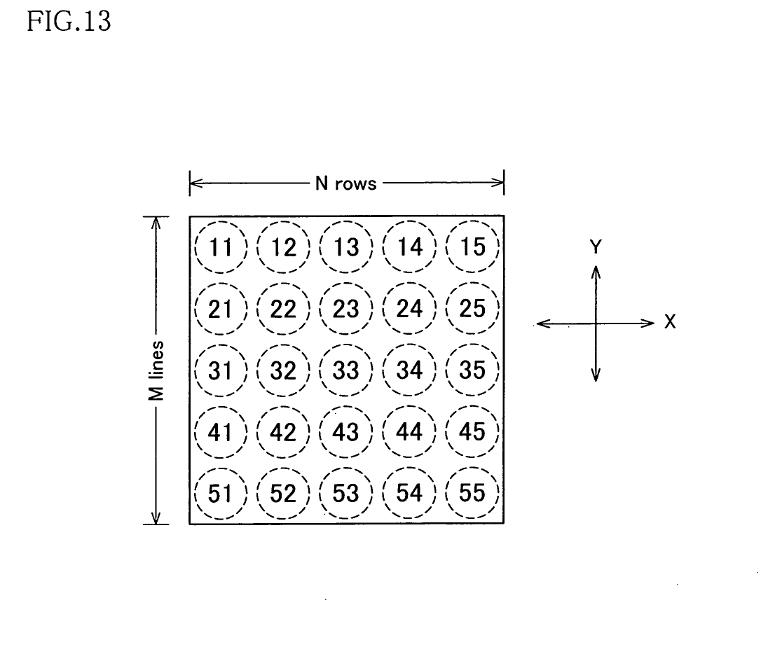

By using four displacement positions as shown in FIGS. 3A through 6B, two-dimensional position detection can be carried out, and therefore precise position control becomes possible. Furthermore, it is preferable that the displacement positions D1 to D4 (inclination angles θd1 to θd4) are arranged so as to be mutually symmetrical with respect to the reference axis BAX since this improves detection accuracy and simplifies the arithmetic processing involved. It should be noted that four displacement positions were used, but there is no limitation to this. Detection accuracy can be further improved by increasing the number of displacement positions (see FIG. 13).

The control mechanism can be simplified by using an embodiment in which the light axis LAX of the light-emitting element 5 rotates from the displacement position D1 to the displacement position D2, to the displacement position D3, and then to the displacement position D4 due to a mechanical operation of the light axis control portion 6.

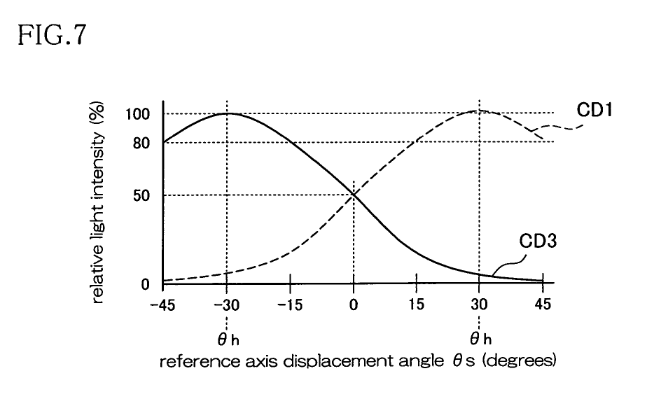

FIG. 7 is an explanatory diagram for describing a principle by which a reference axis displacement angle is detected in a remote control device according to the present invention and is a graph showing correlation between the relative light intensity of the position detection light signal (light-reception signal) detected by the position detection light-receiving element and the reference axis displacement angle as a relative light intensity to reference axis displacement angle characteristic. In this drawing, the horizontal axis is the reference axis displacement angle θs (degrees) and the vertical axis is relative light intensity (%). Identical symbols are attached to structures identical in FIGS. 1 through 6B and description thereof is omitted as appropriate. It should be noted that for reasons of simplicity the inclination angles θd1, θd2, θd3, and θd4 are equivalent to the half value angle θh of the light-emitting element 5 and the half value angle θh is 30 degrees.

In a state (see FIG. 3B) in which the light axis LAX of the light-emitting element 5 is controlled (displaced) to the displacement position D1 by the light axis control portion 6, a relative light intensity to reference axis displacement angle characteristic is as shown in the graph indicated by a curve CD1.

That is, when the reference axis displacement angle θs is 0 degrees, the relative light intensity of the light-reception signal detected by the position detection light-receiving element 3p (the amount of light received from the light-emitting element 5 with respect to the position detection light signal LSp) is 50%. Furthermore, when the reference axis displacement angle θs has displaced from 0 degrees to the plus direction, that is, when the optical indicator device 1 is displaced to the plus direction, the light axis LAX approaches the front surface direction of the position detection light-receiving element 3p, and therefore the relative light intensity gradually becomes greater. When the reference axis displacement angle θs displaces to a direction of 30 degrees (half value angle θh), the light axis LAX positions directly in front of the position detection light-receiving element 3p, and therefore the relative light intensity becomes a maximum value (100%). Further still, when the reference axis displacement angle θs has displaced from 0 degrees to the minus direction, that is, when the optical indicator device 1 is displaced to the minus direction, the light axis LAX moves further away from the front surface direction of the position detection light-receiving element 3p, and therefore the relative light intensity gradually becomes smaller and attenuates.

Furthermore, in a state (see FIG. 5B) in which the light axis LAX of the light-emitting element 5 is controlled (displaced) to the displacement position D3 by the light axis control portion 6, a relative light intensity to reference axis displacement angle characteristic is as shown in the graph indicated by a curve CD3.

That is, when the reference axis displacement angle θs is 0 degrees, the relative light intensity of the light-reception signal detected by the position detection light-receiving element 3p (the amount of light received from the light-emitting element 5 with respect to the position detection light signal LSp) is 50%. Furthermore, when the reference axis displacement angle θs has displaced from 0 degrees to the minus direction, that is, when the optical indicator device 1 is displaced to the minus direction, the light axis LAX approaches the front surface direction of the position detection light-receiving element 3p, and therefore the relative light intensity gradually becomes greater. When the reference axis displacement angle θs displaces to a direction of minus 30 degrees (half value angle θh), the light axis LAX positions directly in front of the position detection light-receiving element 3p, and therefore the relative light intensity becomes a maximum value (100%). Further still, when the reference axis displacement angle θs has displaced from 0 degrees to the plus direction, that is, when the optical indicator device 1 is displaced to the plus direction, the light axis LAX moves further away from the front surface direction of the position detection light-receiving element 3p, and therefore the relative light intensity gradually becomes smaller and attenuates.

As is evident from the aforementioned relative light intensity to reference axis displacement angle characteristic, the relative light intensity that is detected varies in accordance to the displacement position (D1 to D4) of the light axis LAX and the displacement state of the reference axis displacement angle θs. As long as at least two locations of displacement positions of the light axis LAX are symmetrical, one-dimensional detection can be achieved. And if at least four locations are symmetrical, then two-dimensional detection can be achieved.

Accordingly, by determining in advance a relative light intensity to reference axis displacement angle characteristic, emitting as output the position detection light signal LSp in response (synchronized) to displacement positions of the light-emitting element 5 (for example, displacement positions D1, D2, D3, and D4), measuring the relative light intensity received as input at the position detection light-receiving element 3p synchronized to this, and performing arithmetic processing using a difference, a ratio, or a difference and a ratio of the measured relative light intensities, the displacement state (displacement direction and reference axis displacement angle θs) of the optical indicator device 1 (reference axis displacement angle θs) can be grasped.

For example, when the reference axis displacement angle θs is displaced 30 degrees in the horizontal and rightward direction, the relative light intensity is detected as 100% while the light-emitting element 5 is at the displacement position D1 and the relative light intensity is detected as 6% while the light-emitting element 5 is at the displacement position D3. By obtaining a difference in relative light intensities (relative light intensity 100 at displacement position D1—relative light intensity 6 at displacement position D3=94(%)), a ratio of relative light intensities (relative light intensity 100 at displacement position D1/relative light intensity 6 at displacement position D3=approximately 16.7), or by obtaining a difference and a ratio, it is possible to grasp the displacement state of the reference axis displacement angle θs, which has been made to correspond in advance. That is, here it is possible to detect that the reference axis BAX is displaced 30 degrees in the horizontal and rightward direction.

The aforementioned example was described for the case of the horizontal direction, but naturally a reference axis displacement angle θs can be similarly obtained in the vertical direction. Furthermore, it goes without saying that the displacement state of the reference axis displacement angle θs can be similarly obtained also in cases of displacement in both the horizontal and vertical direction (displacement in all four directions).

That is to say, in the remote control device, by displacing the light-emitting element sequencially to predetermined displacement positions (for example, displacement positions D1, D2, D3, and D4) of the optical indicator device 1, supplying a light emission signal (for example, an electric current signal in the case of an LED) to the light-emitting element 5 at each displacement position and emitting as output the position detection light signal LSp, then sequencially detecting the light-reception signals (relative light intensity, output level) that is received as input by the position detection light-receiving element 3p of the light-receiving device 3, and performing arithmetic processing as appropriate on the detected light-reception signals, the displacement state (displacement direction and reference axis displacement angle θs) of the reference axis displacement angle θs is detected.

It should be noted that by specifying in advance the order of displacement of the predetermined displacement positions D1, D2, D3, and D4, detection of the light-reception signals corresponding to the displacement positions can be carried out easily. Furthermore, it is possible to specify the displacement position (mainly displacement direction) at which the reference axis displacement angle θs is maximum from a graph in which the relative light intensity of light-reception signals corresponding to each displacement position becomes maximum.

Accordingly, the remote control device can obtain both directions (both XY directions on plane coordinates) of the reference axis displacement angle θs at the horizontal direction (a first direction) and the vertical direction (a second direction that vertically intersects the first direction). The displacement state of the reference axis displacement angle θs (displacement direction and reference axis displacement angle θs) itself indicates a position signal (movement direction and movement amount) of the optical indicator device 1 and thus can be made to correspond to the position signal of the pointer 4, so that by processing the reference axis displacement angle θs (the change in the reference axis displacement angle θs) as an indication signal (movement direction and movement amount) for the pointer 4 using a microcomputer (CPU: central processing unit), movement (movement direction and movement amount) of the pointer 4 on the display screen (flat surface) can be controlled.

FIGS. 8A and 8B are explanatory diagrams for illustrating a structure of an electromagnetic drive device as another working example of a light axis control portion. FIG. 8A is a front view showing principal components of the electromagnetic drive device as seen from a light-receiving device (light-receiving element) side (that is, as viewed from the front). FIG. 8B is an outline cross section showing principal components along the line from the arrows 8B-8B in FIG. 8A.

The electromagnetic drive device is principally constituted by movable coils 10a to 10d (referred to as “movable coil(s) 10” when there is no need to differentiate each of the movable coils 10a to 10d), plate spring frame portions 11a and 11b (referred to as “plate spring 11” when there is no need to differentiate each of the plate spring frame portions 11a and 11b), which constitute a plate spring 11, a frame structure 12, magnets 13a to 13d (referred to as “magnet(s) 13” when there is no need to differentiate the magnets 13a to 13d), and a latching portion 14. It should be noted that, with the magnets 13, the frame structure 12 constitutes a magnetic circuit, as appropriate.

The light-emitting element 5, which is connected to the electromagnetic drive device, is constituted by a substrate portion 5b, a light-emitting diode chip 5c mounted on the substrate portion 5b, and a resin lens portion 5r that both protects the light-emitting diode chip 5c and prescribes a light intensity distribution characteristic.

The movable coils 10a to 10d are connected at side surfaces of the substrate portion 5b, and the plate spring 11 (the plate spring frame portion 11a) is attached to the movable coils 10a and 10c, which are arranged in the Y-axis direction. The plate spring frame portion 11a and the plate spring frame portion 11b, which are arranged inside and outside the plate spring 11, are connected in the X-axis direction and the plate spring frame portion 11b is supported by the frame structure 12. The magnets 13a to 13d are respectively arranged on the frame structure 12 facing the movable coils 10a to 10d. The latching portion 14, which latches the substrate portion 5b such that it can pivot (light axis can be displaced), is provided at a bottom surface of the frame structure 12.

That is to say, the light-emitting element 5 takes a form (a movable element portion) arranged such that it can be displaced and rotated in an inside space formed by the frame structure 12 with the plate spring 11. Furthermore, the plate spring 11 (the plate spring frame portion 11a and the plate spring frame portion 11b) is configured to supply an electric current to the movable coils 10 by having a metal thin plate applied to both sides of an insulating thin film. Moreover, the movable coils 10b and 10d, which are arranged in positions facing each other, are serially connected, and the movable coils 10a and 10c, which are arranged in positions facing each other, are serially connected.

In regard to the pair of serially connected movable coils 10b and 10d, the direction of an electric current that flows to the movable coils is prescribed such that when an attracting force (or a repulsive force) is produced between the movable coil 10b and the magnet 13b, a repulsive force (or an attracting force) is produced between the movable coil 10d and the magnet 13d. Since the electric current flowing to the coils at the movable coils 10b and 10d is the same, the attracting force and the repulsive force that are produced are opposite in direction but of the same magnitude. That is, the displacement positions D1 and D3 of the light axis LAX can be set symmetrically.

Furthermore, in regard to the pair of serially connected movable coils 10a and 10c, the direction of an electric current that flows to the movable coils is prescribed such that when an attracting force (or a repulsive force) is produced between the movable coil 10a and the magnet 13a, a repulsive force (or an attracting force) is produced between the movable coil 10c and the magnet 13c. Since the electric current flowing to the coils at the movable coils 10a and 10c is the same, the attracting force and the repulsive force that are produced are opposite in direction but of the same magnitude. That is, the displacement positions D2 and D4 of the light axis LAX can be set symmetrically.

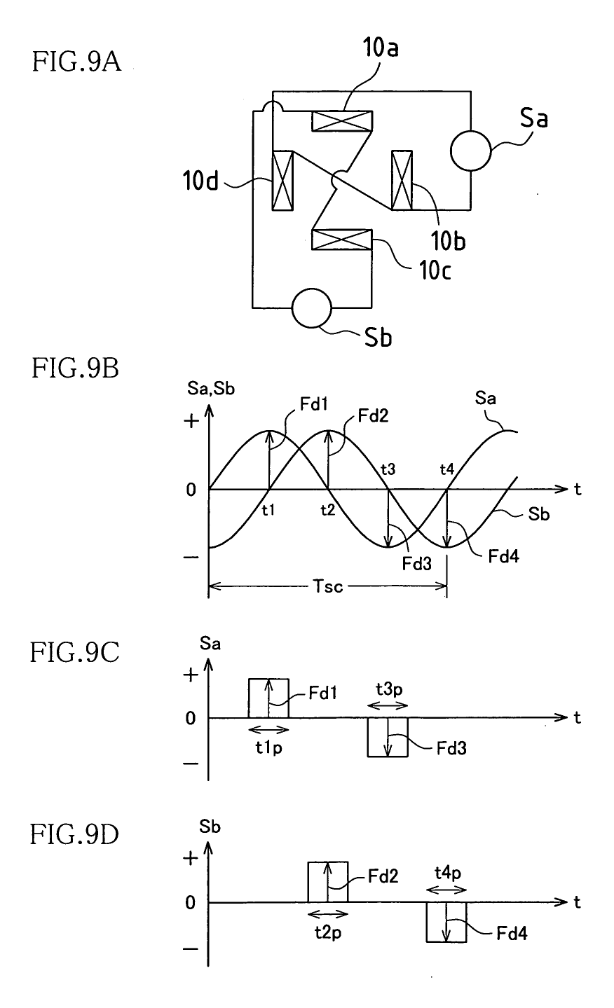

An attracting force and a repulsive force can be produced between the movable coils 10 and the magnets 13 by applying an electric current to the movable coils 10, and therefore the light axis of the substrate portion 5b (the light-emitting diode chip 5c), that is, the light-emitting element 5, connected to the movable coils 10 can be displaced. By sequencially changing the phase of the electric current waveform applied to the movable coils 10 (see light axis control signals Sa and Sb in FIGS. 9A through 9D), the light axis LAX can be made to sequencially change to the displacement positions D2, D3, and D4.

For example, when an attracting force Fd1p is produced between the movable coil 10d and the magnet 13d, and a repulsive force Fd1q is produced between the movable coil 10b and the magnet 13b by applying an electric current of a predetermined direction to the X-axis direction movable coils 10b and 10d, a rotational force Fd1 (a resultant force of the attracting force Fd1p and the repulsive force Fd1q) is effected on the light-emitting element 5 at the displacement center Pr, and therefore the light axis LAX tilts by the inclination angle θd1 and displaces to the displacement position D1. Consequently, the light-emitting element 5 can be set to a state shown in FIG. 3B. Furthermore, when the direction of the electric current is reversed, the light axis tilts by the inclination angle θd3 and displaces to the displacement position D3. Consequently, the light-emitting element 5 can be set to a state shown in FIG. 5B.

FIGS. 9A through 9D are explanatory diagrams for describing examples of the light axis control signals (electric current waveforms) that are supplied to the movable coils of the electromagnetic drive device shown in FIGS. 8A and 8B. FIG. 9A is a wiring explanatory diagram illustrating an outline of the circuit structure, FIG. 9B is a waveform diagram of when the light axis control signal is set to a sine wave, and FIGS. 9C and 9D are waveform diagrams of when the light axis control signal is set to a pulse wave.

As shown in the circuit structure illustrated in FIG. 9A, a light axis control signal Sa is applied to the serially connected movable coils 10b and 10d, and a light axis control signal Sb, which has a different phase from the light axis control signal Sa, is applied to the serially connected movable coils 10a and 10c. That is, the two types of light axis control signals Sa and Sb are supplied to the movable coils as the electromagnetic drive device.

The vertical axis in FIG. 9B is the light axis control signals Sa and Sb and the horizontal axis is time t. The phases of the light axis control signals Sa and Sb are 90 degrees different, the frequency is a sine wave of 200 Hz, for example, and a cycle Tsc becomes 5 ms (milliseconds).

At the time t1, the light axis control signal Sa is plus (maximum) and the light axis control signal Sb is zero, and therefore the rotational force Fd1 for example is produced and the light axis LAX goes to the displacement position D1. At the time t2, the light axis control signal Sb is plus (maximum) and the light axis control signal Sa is zero, and therefore a rotational force Fd2 for example is produced and the light axis LAX goes to the displacement position D2. Furthermore, at the time t3, the light axis control signal Sa is minus (maximum) and the light axis control signal Sb is zero, and therefore a rotational force Fd3 of a reverse direction to the rotational force Fd1 is produced for example, and the light axis LAX goes to the displacement position D3. And at the time t4, the light axis control signal Sb is minus (maximum) and the light axis control signal Sa is zero, and therefore a rotational force Fd4 of a reverse direction to the rotational force Fd2 is produced for example, and the light axis LAX goes to the displacement position D4.

That is, the light axis control signals Sa and Sb of sine waves having phases that are 90 degrees different are applied to the movable coils 10 such that the displacement position of the light axis LAX sequencially changes from the displacement position D1, to the displacement position D2, to the displacement position D3, and to the displacement position D4. Furthermore, the sine wave light axis control signals Sa and Sb change gradually and continuously, and therefore it is possible to allow the light axis LAX to perform an inverted cone rotational motion with the displacement center Pr as the apex.

The vertical axes in FIGS. 9C and 9D are respectively the light axis control signals Sa and Sb and the horizontal axes are time t. The light axis control signals Sa and Sb are the sine waves of FIG. 9B made into pulse waves. The phase, frequency, and cycle are fundamentally the same as FIG. 9B, the point of difference being that the signals are pulse waves. Since the light axis control signals Sa and Sb are changed to a pulse form, it is not possible to change the light axis LAX in a continuous inverted cone form as in the case of sine waves, but rotational forces Fd1, Fd2, Fd3, and Fd4 are produced respectively in the periods (amplitude value periods) t1p, t2p, t3p, and t4p in which the pulses are supplied, so that a displacement position D1, a displacement position D2, a displacement position D3, and a displacement position D4 of four directions independent of each other are obtained (X-Y scanning mode). Furthermore, since no rotational force is produced when pulses are not applied (signal at 0 level), the light axis LAX indicates the neutral point position Dn.

Since the time in which the light axis LAX is in each displacement position (D1 to D4) is short in the case of FIG. 9B, it would be difficult to synchronize light emission control of the light emission control portion (see the position detection light emission control circuit 22 in FIG. 10) to the displacement position of the light axis LAX, but in FIGS. 9C and 9D, the displacement positions of the light axis LAX are fixed in periods (t1p, t2p, t3p, and t4p) having a predetermined length, and therefore light emission control synchronized to the displacement position of the light axis LAX can be carried out extremely easily and stably.

FIG. 10 is an outline circuit block diagram for describing an outline circuit of an optical indicator device according to the present invention using an electromagnetic drive device as a light axis control portion.

The circuit of the optical indicator device 1 is configured having a power source Bat, which is constituted by an ordinary battery, connected to a predetermined circuit. Connected to the power source Bat are, for example, a central processing unit (CPU) 20 central to various arithmetic control, a light axis control circuit 21, a position detection light emission control circuit 22 as a light emission control portion, and a function control light emission circuit 23.

The CPU 20 inputs various signals, carries out preprogrammed, predetermined arithmetic, outputs required control signals, and carries out control of the light axis control circuit 21, the position detection light emission control circuit 22, the function control light emission circuit 23, and the like.

The light axis control circuit 21 outputs the light axis control signals Sa and Sb for controlling the drive of the light axis control portion 6 and supplies these to the light axis control portion 6. A switch Sw1 is inserted between the light axis control circuit 21 and the power source line, and this controls the on/off (operating and non-operating) of the light axis control circuit 21. That is, unnecessary power consumption can be prevented by putting the light axis control circuit 21 into an operating state to control the drive of the light axis control portion 6 only when the displacement position of the light axis LAX is being controlled.

The position detection light emission control circuit 22 is serially connected to the light-emitting element 5, and the position detection light signal LSp is emitted as output by supplying a light emission signal (an electric current signal for example in the case of an LED) to the light-emitting element 5. The position detection light emission control circuit 22 is connected to the light axis control circuit 21 and the switch Sw1, and is configured to operate synchronized to the light axis control circuit 21. That is, it is configured such that the position detection light signal LSp is emitted as output only when the light axis LAX is in a predetermined displacement position (the displacement positions D1, D2, D3, and D4 for example).

It should be noted that synchronization of the light axis control circuit 21 and the position detection light emission control circuit 22 can be controlled easily by the CPU 20 by writing in a program in advance. Furthermore, it is also easy to provide such a synchronization function in the light axis control circuit 21 and the position detection light emission control circuit 22.

The function control light emission circuit 23 is serially connected to a light-emitting element 24 that emits as output a function control light signal LSc, and the function control light signal LSc can be emitted as output by supplying an electric current to the light-emitting element 24. A switch Sw2 is inserted between the function control light emission circuit 23 and the power source line, and this controls the on/off (operating and non-operating) of the function control light emission circuit 23. That is, unnecessary power consumption can be prevented by putting the function control light emission circuit 23 into an operating state to emit as output the function control light signal LSc only when the functions of the display device 2 are being controlled.

By making the light emission wavelength of the light-emitting element 5 and the light emission wavelength of the light-emitting element 24 different, reception of input at the light-receiving device 3 (the function control light-receiving element 3c and the position detection light-receiving element 3p) can be carried out reliably. For example, the light emission wavelength of the light-emitting element 5 can be set to the infrared light region and the light emission wavelength of the light-emitting element 24 can be set to the visible light region, such that it is possible to set the wavelength selection characteristic (detection wavelength) of the position detection light-receiving element 3p to the infrared light region and the wavelength selection characteristic (detection wavelength) of the function control light-receiving element 3c to the visible light region in correspondence to this.

It should be noted that by using a time-division system, the position detection light emission control circuit 22 and the function control light emission circuit 23 can be combined in use as appropriate. That is, it is possible to combine in use the light-emitting element 5 and the light-emitting element 24 with the same light-emitting element. By combining in use a light-emitting element, the mounting of light-emitting elements can be simplified, allowing the structure of the optical indicator device 1 to be simplified. Accordingly, a simple structured and low cost remote control device can be achieved.

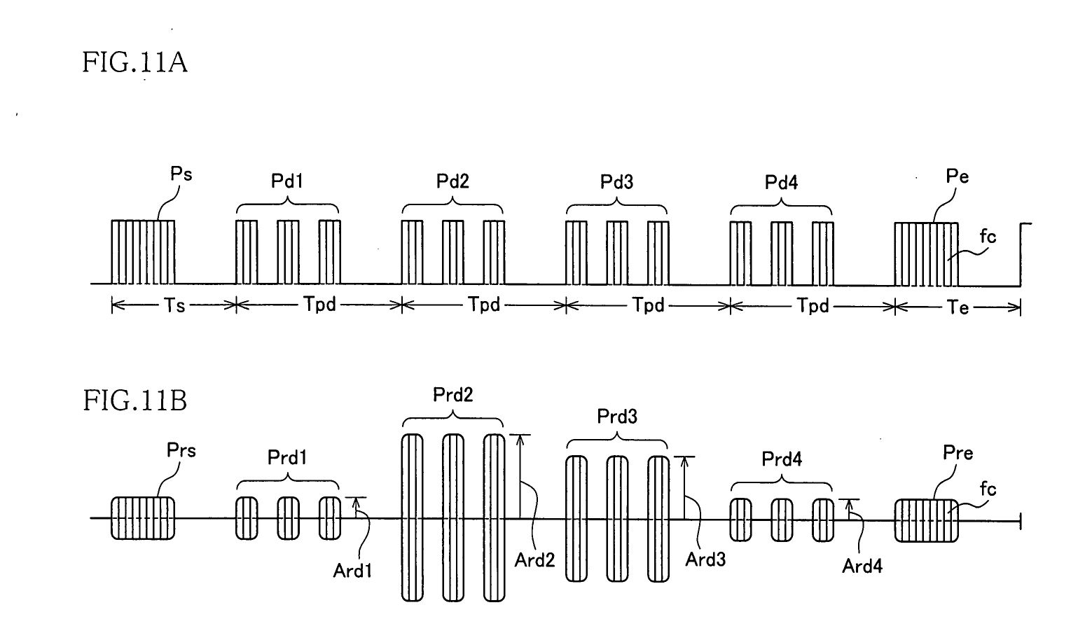

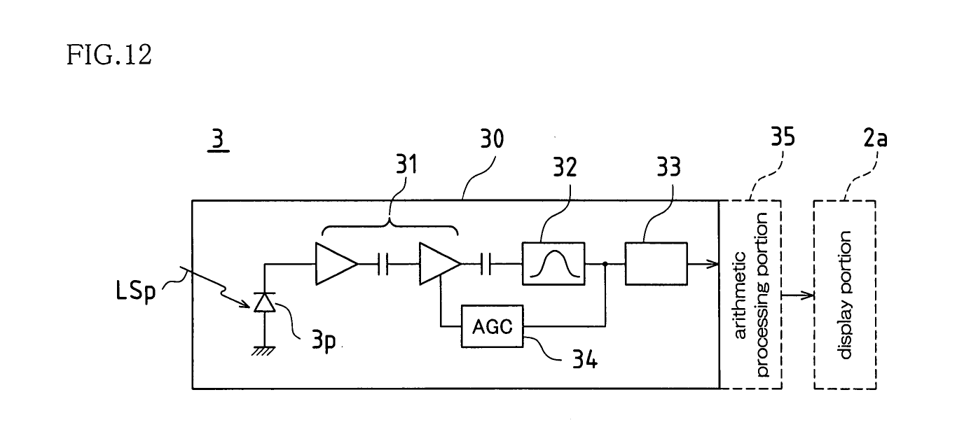

FIGS. 11A and 11B are waveform diagrams showing waveform examples of the light emission signals applied to the position detection light-emitting elements to emit as output the position detection light signals and the light-reception signals obtained from the position detection light signals that the position detection light-receiving elements receive as input. FIG. 11A shows light emission signals and FIG. 11B shows light-reception signals as have been outputted from a band-pass filter. A waveform example is shown in which the light-reception signals have been outputted from a band-pass filter 32 (see FIG. 12).

The light emission signals are constituted as pulse waves. For example, a detection start pulse Ps is produced in a detection start pulse cycle Ts, and position detection pulses Pd1, Pd2, Pd3, and Pd4 are respectively produced during four cycles of position detection pulse cycles Tpd following after the detection start pulse cycle Ts, and a detection finish pulse Pe is produced in a detection finish pulse cycle Te following after the four cycles of position detection pulse cycles Tpd.

The detection start pulse cycle Ts, the position detection pulse cycles Tpd, and the detection finish pulse cycle Te are cycles (of 1 ms to several ms for example) that are set to those used in general remote control devices, and therefore the movement of the pointer 4 can be controlled speedily and smoothly.

Furthermore, by superimposing onto the light emission signals modulation carrier waves fc of a frequency in the range of 10 kHz to 40 kHz that are ordinarily used, detection errors due to disturbance light (noise) can be prevented. By employing modulation carrier waves fc of an extent ordinarily used, configuration is possible using components of substantially the same specification as the circuit component for emitting as output the function control light signal LSc, and therefore simple, low-cost manufacturing is possible.

It should be noted that the light emission signals can be produced in continuous repetition while the switch Sw1 (see FIG. 10) is in an on state, such that the movement of the pointer 4 can be controlled stably.

The position detection pulses Pd1, Pd2, Pd3, and Pd4 are respectively produced corresponding (synchronized) to the displacement positions D1, D2, D3, and D4 of the light axis LAX. That is to say, the position detection pulses Pd1, Pd2, Pd3, and Pd4 are respectively produced synchronized to periods t1p, t2p, t3p, and t4p for example. Furthermore, the position detection pulses Pd1, Pd2, Pd3, and Pd4 are respectively constituted by a plurality of pulses (three pulses are shown for example), and therefore the position detection light signal LSp can be stably emitted as output and received as input.

The light-reception signals are detected synchronized to the light emission signals and become pulse waves constituted by a detection start light-reception pulse Prs, position detection light-reception pulses Prd1, Prd2, Prd3, and Prd4, and a detection finish light-reception pulse Pre. The position detection light-reception pulses Prd1, Prd2, Prd3, and Prd4 respectively indicate different amplitude values corresponding to the displacement state of the reference axis BAX. For example, the position detection light-reception pulses Prd1, Prd2, Prd3, and Prd4 respectively indicate amplitude values Ard1, Ard2, Ard3, and Ard4. By comparing these amplitude values, the displacement state of the reference axis BAX (displacement direction and reference axis displacement angle θs) can be known.

For example, the amplitude value Ard2 is the largest of the amplitude values Ard1, Ard2, Ard3, and Ard4, and therefore the displacement direction of the reference axis BAX can be known. Furthermore, by comparing the amplitude value Ard1 and the amplitude value Ard3 (for example comparing their difference, their ratio, or comparing a combination of their difference and ratio), the displacement state (reference axis displacement angle θs) of the reference axis BAX in the horizontal direction can be known, and by comparing the amplitude value Ard2 and the amplitude value Ard4, the displacement state (reference axis displacement angle θs) of the reference axis BAX in the vertical direction can be known, which is as described in FIGS. 2A through 7. It should be noted that the amplitude values are analog values, and that by performing analog-digital conversion and converting to appropriate digital values, arithmetic can be carried out easily.

Furthermore, by averaging the light-reception signals (amplitude values) of the plurality (for example, three) pulses of the respective displacement positions D1, D2, D3, and D4, the light-reception signals can be obtained with excellent accuracy, thus allowing position detection with excellent accuracy. It should be noted that an average of the plurality of amplitude values may be obtained from one of the amplitude value detection circuit 33 (see FIG. 12) and the arithmetic processing portion 35 (see FIG. 12).

FIG. 12 is a block diagram showing a working example of a circuit block of the light-receiving device in a remote control device according to the present invention.

The light-receiving device 3 detects the light intensity (amplitude value of the light-reception signal) of the position detection light signal LSp, which is received as input, using a light-receiving circuit 30, and the displacement state of the reference axis BAX (displacement direction and reference axis displacement angle θs), that is, a position signal (movement direction and movement amount) of the optical indicator device 1, is obtained by performing arithmetic processing on the detected amplitude values with the arithmetic processing portion 35, with the position signal being outputted to perform movement control of the position of the pointer 4 displayed on the display portion 2a. The arithmetic processing portion 35 can be configured by a central processing unit (CPU) such as a microcomputer for example, and it is possible to use as appropriate a CPU built into the display device 2.

The light-receiving circuit 30 is constituted by a position detection light-receiving element 3p, an amplifier circuit 31, a band-pass filter 32, an amplitude value detection circuit 33, and an automatic gain control circuit (AGC) 34. The position detection light-receiving element 3p selectively receives as input (detects) the position detection light signal LSp that is emitted as output from the light-emitting element 5 to detect a light-reception signal (a light-reception signal corresponding to the light emission signal), and outputs to the amplifier circuit 31. The position detection light-receiving element 3p can be constituted by a photodiode or a phototransistor for example, and can be provided with an optical filter having an appropriate wavelength selection characteristic.

The amplifier circuit 31 amplifies to an appropriate level the light-reception signal that is outputted from the position detection light-receiving element 3p. The band-pass filter 32 reduces noise by allowing to pass only signals of a predetermined frequency from the light-reception signals amplified by the amplifier circuit 31, thus improving detection accuracy. The amplitude value detection circuit 33 detects the amplitude values (light intensity, relative light intensity, output level) of light-reception signals outputted from the band-pass filter 32.

The AGC 34 detects the maximum value of the amplitude values of the light-reception signals (the position detection light-reception pulses Prd1, Prd2, Prd3, and Prd4) outputted from the band-pass filter 32 corresponding to the position detection pulses Pd1, Pd2, Pd3, and Pd4, and regulates the amplification factor of the amplifier circuit 31 so that (the maximum value of) the amplitude values of the light-reception signals does not saturate. Since (the maximum values of) the amplitude values do not saturate, it is possible to obtain a light-reception signal (light-reception signal level) that has high detection accuracy, and high stability and reliability. For example, a configuration is possible in which the series of cycles of the detection start pulse cycle Ts, the position detection pulse cycles Tpd, and the detection finish pulse cycle Te are repeated a plurality of times, and the regulation is performed based on the maximum amplitude value detected in the initial cycle (first cycle), and the amplitude value of a control target is detected in the second cycle onward.

The position signals are obtained by the arithmetic processing portion 35 performing, as appropriate, arithmetic processing on the amplitude values (light intensity, relative light intensity, output level) of the light-reception signals detected by the amplitude value detection circuit 33, and the position of the pointer 4 can be controlled by outputting these as position signals (position control signals) from the arithmetic processing portion 35 to the display portion 2a. It should be noted that the amplitude values are analog values, and therefore it is necessary to perform analog-digital conversion to convert these to appropriate digital values, and this analog-digital conversion may be carried out by either the amplitude value detection circuit 33 or the arithmetic processing portion 35.

The light-receiving device 3 is further provided with a function light-receiving circuit (not shown) for receiving as input the function control light signal LSc that is emitted as output from the light-emitting element 24 corresponding to the function control signal that controls the functions of the display device 2 (display portion 2a). The function light-receiving circuit detects (outputs) as the function control signal the function control light signal LSc, which is received as input by the function control light-receiving element 3c (see FIG. 1) through a well-known signal conversion and the functions of the display device 2 (display portion 2a) are controlled using the arithmetic processing portion 35 or the like. It should be noted that it is possible to combine the position detection light-receiving element 3p and the function control light-receiving element 3c by devising the control mode and transmission mode in such ways as employing a time-division system. By making combined use of a light-receiving element, the light-receiving component structure of the light-receiving device 3 can be simplified.

Furthermore, by bottom holding the noise level in the period in which there is no signal of light-reception signals (a period of zero level pulses) and setting the difference between each signal (amplitude value) and the bottom-hold value (reference level) as the active signal level (amplitude value), it is possible to achieve more highly accurate level determination in which noise levels are eliminated, thus allowing high-accuracy position control. This process can be achieved by writing in an appropriate program to the arithmetic processing portion 35.

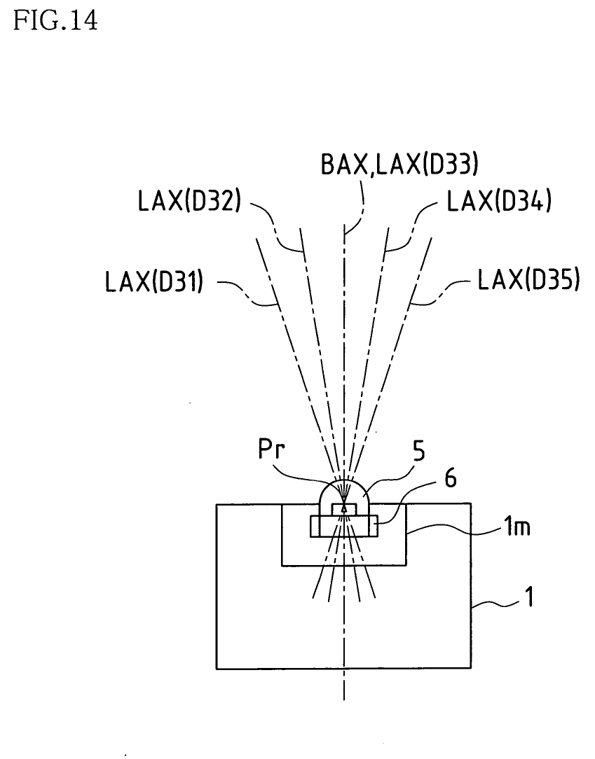

FIG. 13 is a pattern diagram that schematically illustrates a front view of an example of a light axis distribution pattern (M×N matrix) when the number of light axis displacement positions has been increased. FIG. 14 is a lateral schematic view showing displacement states of light axes corresponding to when the line M=3 in FIG. 13 along with lateral principal components of the optical indicator device.

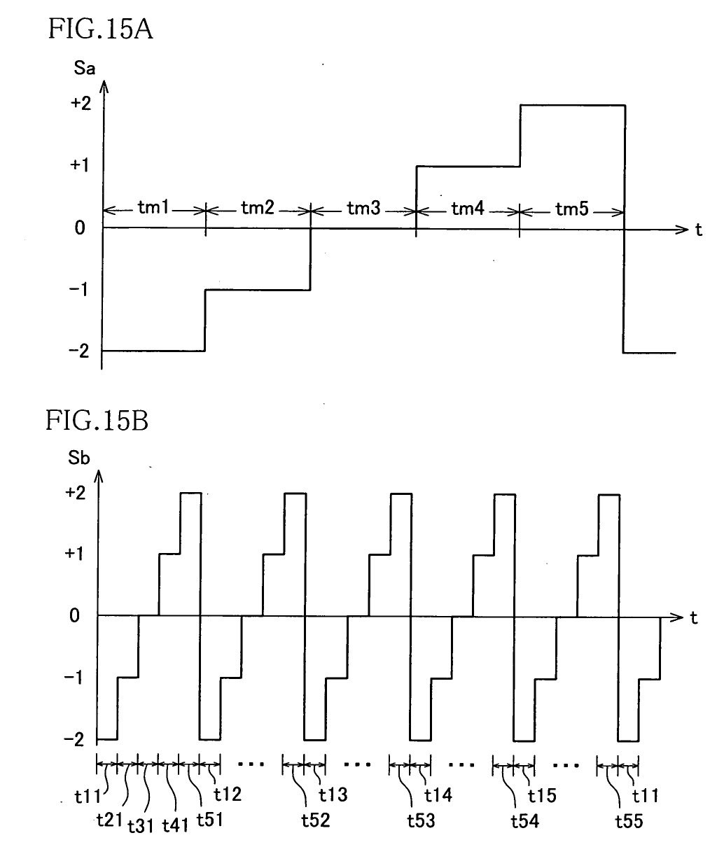

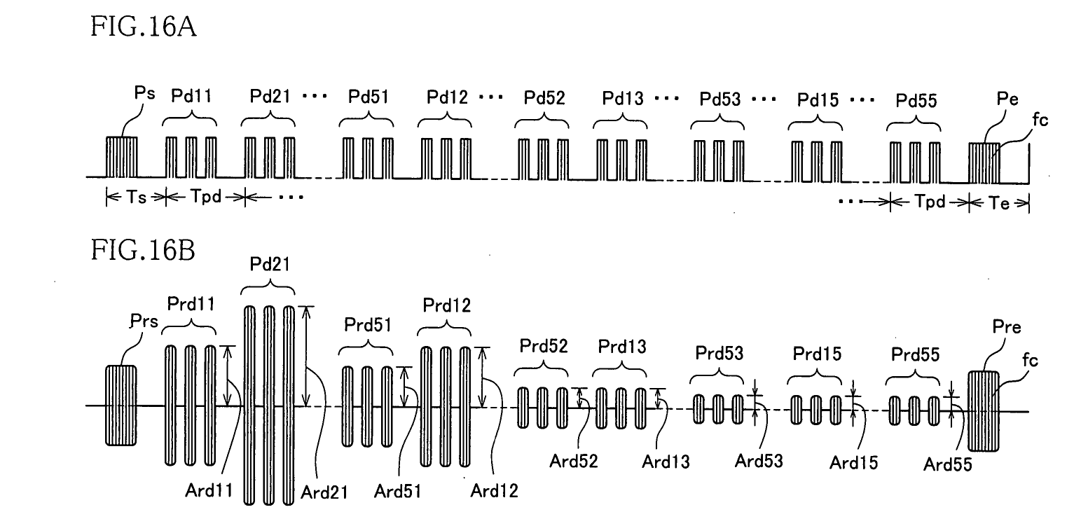

In FIG. 13, displacement positions (displacement states) of the light axis LAX are shown in an M×N (M lines, N rows) matrix in which M=N=5. It should be noted that in consideration of the level of precision and symmetry, it is preferable for the matrix to be set to M=N and that M=3 or higher. An “MN” number (matrix) indicates each displacement position. For example, matrix “31” refers to a displacement position D31. Matrix-shape displacement positions such as this can be obtained easily (see FIGS. 15A through 16B) by regulating the light axis control signals supplied to the movable coils 10 of the electromagnetic drive device shown in FIGS. 8A and 8B.

FIG. 14 shows the displacement states of the light axis LAX when M=3 for example, namely displacement positions (D31, D32, D33, D34 and D35) indicated by matrices “31,” “32,” “33,” “34,” and “35.” That is, in a line where M=3, there is no displacement in the Y-axis direction (line direction) and two locations of displacement positions to the left and right in the drawing in the X-axis direction (row direction). In comparison to FIG. 3B and FIG. 5B, the displacement position D31 corresponds to the displacement position D1, the displacement position D35 corresponds to the displacement position D3, and the displacement position D33 corresponds to the neutral point position Dn. Furthermore, the displacement position D32 is a displacement position midway between the displacement position D31 and the neutral point position Dn, and the displacement position D34 is a displacement position midway between the displacement position D35 and the neutral point position Dn. That is to say, very fine position control becomes possible for the displacement positions of the light axis LAX. The same is true for other matrices and therefore detailed description thereof is omitted.

There were four locations (displacement positions D1, D2, D3, and D4) of displacement positions in the case of the optical indicator devices (light-emitting elements) shown in FIGS. 3A through 6B, but 24 locations (excluding the neutral point position Dn=D33) of displacement positions are provided in the present working example. Finer control of the displacement position of the light axis LAX is carried out compared to FIGS. 2A through 6B, and therefore the control resolution of the displacement state of the reference axis BAX can be improved, and the position signals obtained by the light-receiving device 3 also become finer signals, such that even finer position control (movement control) of the pointer 4 can be achieved.

FIGS. 15A and 15B are waveform diagrams of working examples of the light axis control signals applied to the movable coils to set the displacement position of the light axis shown in FIG. 13.

Matrix shaped displacement positions can be obtained by applying the two types of light axis control signals Sa and Sb (see FIG. 9) as pulse waves of a predetermined form to the movable coils 10. That is, by setting the light axis control signals Sa and Sb to step shaped waveforms that change symmetrically from positive to negative via a zero level or from negative to positive via a zero level, and making a single cycle of each step of the light axis control signal Sa (one of the types of pulse waves) and a cycle of a group of steps of the light axis control signal Sb (the other type of pulse waves) equal, it is possible to achieve the displacement positions shown in FIG. 13. Square matrix shaped displacement positions can be achieved by making equal the number of steps of the light axis control signals Sa and Sb.

The light axis control signal Sa is set to step shaped waveforms in which there is a minus 2 level at a cycle tm1, a minus 1 level at a cycle tm2, a zero level at a cycle tm3, a plus 1 level at a cycle tm4, and a plus 2 level at a cycle tm5, and this is set as a repetitive waveform.

Furthermore, a relationship between the cycles and the displacement positions is such that if the displacement positions of the light axis LAX are set to row N=1 (displacement positions D11 to D51) at the cycle tm1 for example, then the displacement positions of the light axis LAX at the cycle tm2 correspond to row N=2 (displacement positions D12 to D52), the displacement positions of the light axis LAX at the cycle tm3 correspond to row N=3 (displacement positions D13 to D53), the displacement positions of the light axis LAX at the cycle tm4 correspond to row N=4 (displacement positions D14 to D54), and the displacement positions of the light axis LAX at the cycle tm5 correspond to row N=5 (displacement positions D15 to D55).

The light axis control signal Sb is set to step shaped waveforms in which there is a minus 2 level at a cycle t11, a minus 1 level at a cycle t21, a zero level at a cycle t31, a plus 1 level at a cycle t41, and a plus 2 level at a cycle t51 corresponding to the cycle tm1 of one step of the light axis control signal Sa. That is, the cycle tm1 of one step of the light axis control signal Sa and the cycle of one group of steps (t11+t21+t31+t41+t51) of the light axis control signal Sb are set equivalently. Furthermore, the same is true for the cycles tm2, tm3, tm4, and tm5 of the other steps of the light axis control signal Sa such that the cycle of one group of steps (t12 to t52, t13 to t53, t14 to t54, t15 to t55) of the light axis control signal Sb are set to be respectively equivalent.

Furthermore, a relationship between the cycles and the displacement positions is such that if the displacement position of the light axis LAX at the cycle t11 is D11 for example, then the displacement position of the light axis LAX at the cycle t21 corresponds to D21, the displacement position of the light axis LAX at the cycle t31 corresponds to D31, the displacement position of the light axis LAX at the cycle t41 corresponds to D41, and the displacement position of the light axis LAX at the cycle t51 corresponds to D51.

It should be noted that when the displacement position is controlled with such precision it is necessary to improve the mechanical response speed, and it is necessary to make lightweight and miniaturize the light-emitting element 5 and the electromagnetic drive device. For the light-emitting element 5, a high output element is used for the light-emitting diode chip 5c and a resin having a high refractive index is used for the resin lens portion 5r. Furthermore, it is also possible to use a MEMS (micro electro mechanical system) or the like as the drive device.

FIGS. 16A and 16B are waveform diagrams for describing waveform examples of the light emission signals applied to the position detection light-emitting elements synchronized to the light axis displacement positions shown in FIGS. 13, 15A and 15B and the light-reception signals obtained from the position detection light signals that the position detection light-receiving elements receive as input. FIG. 16A shows the light emission signals that are applied, and FIG. 16B shows the light-reception signals. Fundamentally this is the same as was described in FIGS. 11A and 11B and therefore detailed description is omitted.

The light emission signals are constituted as pulse waves and the detection start pulse Ps is produced in the detection start pulse cycle Ts, and position detection pulses Pd11 to P51, Pd12 to P52, Pd13 to Pd53, Pd14 to Pd 54, and Pd15 to Pd55 are respectively produced during 25 cycles of position detection pulse cycles Tpd following after the detection start pulse cycle Ts, and the detection finish pulse Pe is produced in the detection finish pulse cycle Te following after the 25 cycles of position detection pulse cycles Tpd. For example, the position detection pulses Pd11, Pd21, Pd31, Pd41, and Pd51 are produced synchronized respectively to the cycles t11, t21, t31, t41, and t51 (the displacement positions D11, D21, D31, D41, and D51).

The light-reception signals are detected synchronized to the light emission signals and become pulse waves constituted by a detection start light-reception pulse Prs, position detection light-reception pulses Prd11 to Prd51, Prd12 to Prd52, Prd13 to Prd53, Prd14 to Prd54, and Prd15 to Prd55, and a detection finish light-reception pulse Pre. The position detection light-reception pulses Prd11 to Prd51, Prd12 to Prd52, Prd13 to Prd53, Prd14 to Prd54, and Prd15 to Prd55 have respectively different amplitude values corresponding to the displacement state of the reference axis BAX, indicating amplitude values Ard11, Ard21, . . . , Ard55 for example. By comparing these amplitude values, the displacement state of the reference axis BAX (displacement direction and reference axis displacement angle θs) can be known to a very fine high resolution.

FIGS. 17A through 17C are explanatory diagrams (lateral perspective views) for describing a working example in which the displacement position of the light axis of the light-emitting element is controlled using a reflective component in the light axis control portion of the optical indicator device shown in FIGS. 2A and 2B. It should be noted that a front view of the optical indicator device 1 would be the same as FIG. 2A and is therefore omitted. FIG. 17A shows a case in which a reflective component 6m is made to tilt at an inclination angle θrn so that the reference axis BAX of the optical indicator device 1 and the light axis LAX of the light-emitting element 5 are in accord (when the light axis of the light-emitting element 5 is in the neutral point position Dn). FIG. 17B shows a case in which the reflective component 6m is made to tilt at an inclination angle θr1 so that the light axis LAX of the light-emitting element 5 has an inclination angle θd1 in the horizontal and leftward direction as viewed from the front (displacement position D1) with respect to the reference axis BAX. FIG. 17C shows a case in which the reflective component 6m is made to tilt at an inclination angle θr3 so that the light axis LAX of the light-emitting element 5 has an inclination angle θd3 in the horizontal and rightward direction as viewed from the front (displacement position D3) with respect to the reference axis BAX.

The light-emitting element 5 is arranged for example in the horizontal and rightward direction as viewed from the front, and is fixedly arranged such that the light axis irradiates to the displacement center Pr from a position of 45 degrees rightward for example with respect to the reference axis BAX shown in the lateral perspective view. Furthermore, the inclination angles θrn, θr1, and θr3 can be obtained geometrically as appropriate using a formula in which the incident angle equals the reflective angle with respect to a normal line LV of the reflective component 6m, and appropriate control can be achieved by attaching the reflective component 6m to a surface of the electromagnetic drive device (a surface of the substrate portion 5b for example) as described in FIGS. 8A and 8B. Since only attaching the reflective component to a surface of the electromagnetic drive device is required, the weight of moving components can be reduced, thus allowing the load of the electromagnetic drive device to be reduced. Accordingly, it becomes possible to achieve high-speed, low power consumption drive. It should be noted that a mirror (mirror plane plate) for example is suitable for the reflective component 6m.

In these drawings, only horizontal direction control was shown, but naturally the same control can be achieved for the vertical direction as well. Furthermore, the same control can be achieved two-dimensionally with the horizontal direction and the vertical direction. Also, as shown in FIG. 13, the number of displacement positions of the light axis LAX can be further increased.

The present invention can be embodied and practiced in other different forms without departing from the purport and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. A remote control device comprising an optical indicator device in which a light-emitting element is mounted that emits as output a position detection light signal, and a light-receiving device that receives as input the position detection light signal and obtains a position signal from a detected light-reception signal,
wherein the optical indicator device comprises:
a light axis control portion that displaces a light axis of the light-emitting element to displacement positions so that the light axis of the light-emitting element has an inclination angle with respect to a reference axis of the optical indicator device, and
a light emission control portion that causes a position detection light signal to be emitted as output from the light-emitting element when the light axis of the light-emitting element is in the displacement positions.

2. The remote control device according to claim 1, wherein the displacement positions are arranged in symmetrical positions centering on the reference axis.

3. The remote control device according to claim 1, wherein the displacement positions are in at least four locations.

4. The remote control device according to claim 1, wherein the light axis control portion comprises a mechanical component that mechanically controls the displacement positions of the light axis.

5. The remote control device according to claim 1, wherein the light axis control portion comprises an electromagnetic drive device that electromagnetically controls the displacement positions of the light axis.

6. The remote control device according to claim 5, wherein a light axis control signal applied to the electromagnetic drive device has two types of pulse waves having different phases.

7. The remote control device according to claim 6, wherein the two types of pulse waves are respectively step shaped waveforms, with a cycle of each step in one of the types of pulse waves being equivalent to a cycle of a group of steps in another of the types of pulse waves.

8. The remote control device according to claim 1, wherein the light emission control portion applies a light emission signal of pulse waves to the light-emitting element in synchronization to the displacement positions.

9. The remote control device according to claim 8, wherein the light emission signal includes a detection start pulse and a position detection pulse after the detection start pulse.

10. The remote control device according to claim 9, wherein the position detection pulses are constituted by a plurality of pulses having a same pulse width and a same cycle with respect to the respective displacement positions.

11. The remote control device according to claim 8, wherein a modulation carrier wave is superimposed onto the light emission signal.

12. The remote control device according to claim 1, wherein the light-emitting element emits as output a light emission wavelength of an infrared light region.

13. The remote control device according to claim 1, wherein the inclination angle is not greater than a half value angle of the light-emitting element.

14. The remote control device according to claim 1, wherein the light-receiving device comprises a position detection light-receiving element that receives as input the position detection light signal to detect a light-reception signal, an amplifier circuit that amplifies the light-reception signal detected by the position detection light-receiving element, an amplitude value detection circuit that detects an amplitude value of the light-reception signal amplified by the amplifier circuit, and an arithmetic processing portion that performs arithmetic processing on the amplitude value to obtain the position signal.

15. The remote control device according to claim 14, wherein amplitude values obtained for a plurality of pulses of light-reception signals corresponding to the plurality of pulses of the position detection pulses are averaged and the average is set as an amplitude value of the light-reception signals.

16. The remote control device according to claim 14, wherein a band-pass filter is connected between the amplifier circuit and the amplitude value detection circuit.

17. The remote control device according to claim 14, wherein an amplification factor of the amplifier circuit is regulated by an automatic gain control circuit.

18. The remote control device according to claim 17, wherein the amplification factor is regulated such that the amplitude value of the light-reception signal does not saturate.

19. The remote control device according to claim 14, wherein the amplitude value is obtained by setting as a reference level a noise level of the light-reception signal in a period in which there is no signal, and obtaining a difference from the reference level.

20. A display device provided with a display portion that displays information and a frame portion that supports the display portion, comprising the remote control device according to claim 1, wherein the light-receiving device is arranged at a front surface of the frame portion.

21. The display device according to claim 20, wherein the optical indicator device emits as output and transmits to the light-receiving device a function control light signal corresponding to a function control signal that controls a function of the display device, and the light-receiving device receives as input the function control light signal and outputs the function control signal.

22. The display device according to claim 21, wherein the function control light signal is emitted as output from the light-emitting element.

23. The display device according to claim 21, wherein the light-receiving device comprises a function control light-receiving element that receives as input the function control light signal.

24. The display device according to claim 21, wherein the position detection light-receiving element receives as input the function control light signal and detects the function control signal.

25. The display device according to claim 20, wherein a position of a mark displayed on the display portion is controlled according to the position signal.

26. The display device according to claim 20, wherein the display device is a television receiver.
